(19) United States
(12) Patent Application Publication
(10) Pub. No.: US 2009/0211663 A1
(43) Pub. Date: Aug. 27, 2009

(54) AUDIO/VIDEO DISPLAY EQUIPMENT FOR GAS PUMPS

(76) Inventors: Lee David Olesen, Poway, CA (US); Gary Alan LePon, Lahaina, HI (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/389,300

(22) Filed: Feb. 19, 2009

Related U.S. Application Data
(63) Continuation of application No. 11/680,504, filed on Feb. 28, 2007, now abandoned.
Application No. 11/680,504 is a continuation of application No. 10/976,197, filed on Oct. 28, 2004, now abandoned.

(30) Foreign Application Priority Data
Oct. 28, 2003 (CN) 2003101033184.4
Dec. 22, 2003 (CN) 200310121750.6
Dec. 22, 2003 (CN) 200320129817.6

(51) Int. Cl. B67D 5/08; B23P 6/00

(52) U.S. Cl. 141/94; 29/888.021

(57) ABSTRACT

A gasoline pump apparatus comprises one or more pump nozzles, a sensor configured to detect nozzle removal from and replacement to a nozzle storage bay, and a first housing enclosing at least some gas dispensing apparatus. In addition, a second housing encloses at least one video display and at least one video display controller. The at least one video display controller is coupled to the sensor such that the video display output changes with changes in nozzle position. In some embodiments, the second housing is configured to be explosion proof.

### CROSS REFERENCE TO RELATED APPLICATIONS

This application is a continuation of U.S. patent application Ser. No. 11/680,504, filed on Feb. 28, 2007 and entitled Audio/Video Display Equipment for Gas Pumps, which application is a continuation of U.S. patent application Ser. No. 10/976,197, filed on Oct. 28, 2004 and entitled Audio/Video Display Equipment for Gas Pumps. The disclosure of these prior applications is hereby incorporated by reference in its entirety.

### BACKGROUND OF THE INVENTION

1. Field of the Invention

This invention relates to a gas pump with audio/video displays which can play multimedia advertisements.

2. Description of the Related Art

Generally, the functions of gas pumps installed at gas stations are still quite simple, and involve only refilling and gasoline metering functions. When refilling the tank, drivers and passengers typically have nothing to do but wait for the completion of tank refilling.

U.S. Pat. No. 6,601,039 describes a gas pump having an authorization control system that controls the gas pump and that can also display advertising messages and perform commercial transactions during the refilling process.

Although this patent describes one possible approach to implement multimedia displays at a gas pump, improvements in this system are desirable.

### SUMMARY OF THE INVENTION

In one embodiment, the invention comprises a gasoline pump apparatus comprising:

one or more pump nozzles, a sensor configured to detect nozzle removal from and replacement to a nozzle storage bay, and a first housing enclosing at least some gas dispensing apparatus. In addition, a second housing encloses at least one video display and at least one video display controller. The at least one video display controller is coupled to the sensor such that the video display output changes with changes in nozzle position. In some embodiments, the second housing is configured to be explosion proof.

In another embodiment a gasoline pump apparatus comprises one or more pump nozzles; a first housing enclosing at least some gas dispensing apparatus, and a second explosion proof housing attached to the first housing and enclosing at least one video display and at least one video display controller.

Methods of providing a gas pump with media display capability include attaching a second housing to the top of an existing pump apparatus housing, routing power wiring and pump nozzle sensor wiring between the first and second housings, and coupling media display control circuitry in the second housing to a remote control system. The coupling to the remote control system may be performed wirelessly.

### BRIEF DESCRIPTION OF THE DRAWINGS

FIG. 1 is a block diagram of a gas pump display in one embodiment of the invention

FIG. 2 is a front view of a first embodiment of a gas pump implementing one embodiment of the invention;

FIG. 3 is a front view of a second embodiment of a gas pump implementing one embodiment of the invention;

FIG. 4A is a perspective view of one embodiment of a retro-fit housing for audio/video player components in an open configuration;

FIGS. 4B-4D are perspective views of embodiments of retro-fit housings for audio/video player components in a closed configuration;

FIG. 5 is a schematic diagram of a pump nozzle position detector circuit;

FIG. 6 is a schematic diagram of a voltage/current limiting circuit which may be provided as part of an explosion proof design;

FIG. 7 is an exploded view of one embodiment of a semiconductor cooling unit;

FIG. 8 illustrates a semiconductor refrigerator;

FIG. 9 is a flow chart of one method of content display which may be performed by the system.

### DETAILED DESCRIPTION OF THE PREFERRED EMBODIMENT

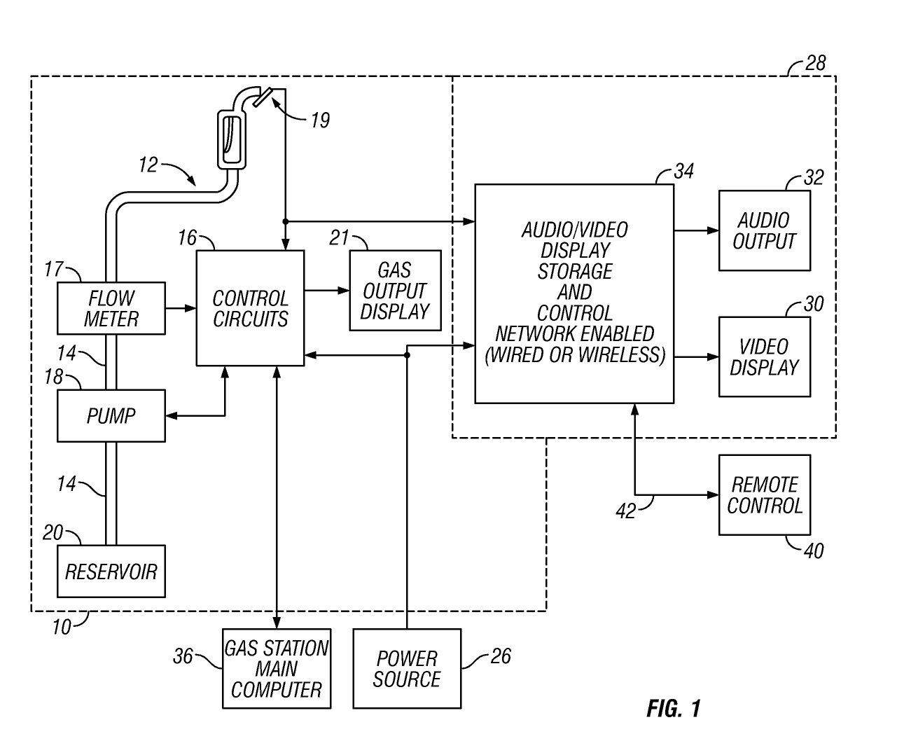

FIG. 1 illustrates a block diagram of one system embodiment. The system includes many conventional gas pump elements. Traditional gas pumps 10, for example, include pump nozzles 12, gas pipes 14 connected with the pump nozzles 12, processing, system control, and motor control circuitry 16, and a pump motor 18. Gas supply pipes are connected with pump nozzles, as are a gas-oil segregator (not shown), a flow meter 17, and one or more sensors/switches 19 that detect nozzle operation by a motorist. In operation, a motorist takes up a pump nozzle which typically trips a sensor switch indicating that the nozzle has been removed from its storage bay. The motorist then turns on the pump nozzle, tripping another signal switch and initiating gasoline flow. The gas pump computer control board receives the signals and drives the pump, pumping gas from the reservoir 20 to the nozzle and into the vehicle. The control circuit monitors the meter on the gas pipe and calculates the amounts for display on a gallon/dollar display 21. When the volume of the fuel reaches the set value/volume or a full tank is sensed, the control circuitry shuts down the pump 18, the refilling stops, and the user places the nozzle back in the storage bay.

The functions of the traditional gas pumps are quite simple, only refilling and metering. The invention aims at installing audio/video players 28, namely, video displays and the sound system on the current gas pumps to play, for example, dynamic multimedia advertisements, news, or other information during the refilling process.

The above mentioned video display device includes a video display 30, a sound system 32 and a controller 34 which can be installed at any place of the gas pump box, such as on the top or in the middle. Especially advantageous embodiments, described further below, interface with the existing pump components in a very simple way. As shown in FIG. 1, the audio/video controller 34 need only connect to the nozzle removal sensor 18a and to the power source 26. The audio/video player components 28 may be incorporated into the housing of a conventional pump 10, or, in some especially advantageous embodiments, the player system 28 is provided as a retro-fit kit comprising a separate housing placed, for example, on top of an existing installed pump 10.

As shown in FIG. 1, the control circuitry 16 associated with the conventional pump operation communicates with the main gas station computer 36. The controller 34 for the audio/video display, however, may communicate with a remote control system 40 via a separate communication path 42. The controller 34 may perform data transmissions and communications with the control system at different places by means of wireless networks (such as CDMA, GPRS, satellites, 802.11 wirelesses LAN) or wired networks (ISDN, ADSL, DDN dedicated lines), or a combination of these methods. It has been found advantageous to implement the communication channel 42 as a standard TCP/IP protocol in which each player 28 is assigned an IP address (static or dynamic) for communication to/from the remote control system 40. In some embodiments, the players connect to the control system via a satellite connection. It has been found especially cost effective to utilize at least some wired communication connections such as DSL or cable modem to a wireless router placed at the gas station facility. The display controllers located at the station are then wirelessly networked via communication path 42 (which is wireless in this embodiment) to share a common incoming internet connection at the gas station.

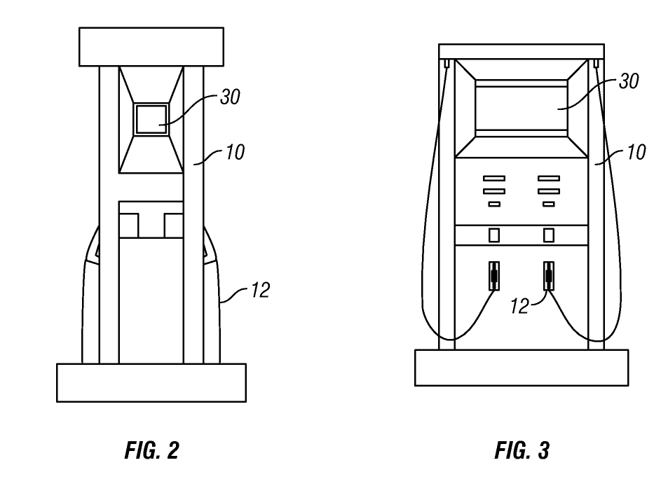

FIGS. 2 and 3 are overall front views of gas pumps with video displays on the top. As shown in these figures, the gas pumps with video displays include the box 10, pump nozzles 12 installed outside the box, gas pipes connected to the pump nozzles and inside the box 10, and the motor and control circuitry which are connected to the gas pumps. The difference between this embodiment and the traditional gas pumps lies in that this embodiment has a video display 30 which plays dynamic video such as advertisements, news, etc. and plays audio with a sound system on the pump box. A controller inside the pump box controlling video displays and the sound system to work properly. In some embodiments, such as shown in FIG. 1, the controller receives only power and a sensor input from the conventional pump components.

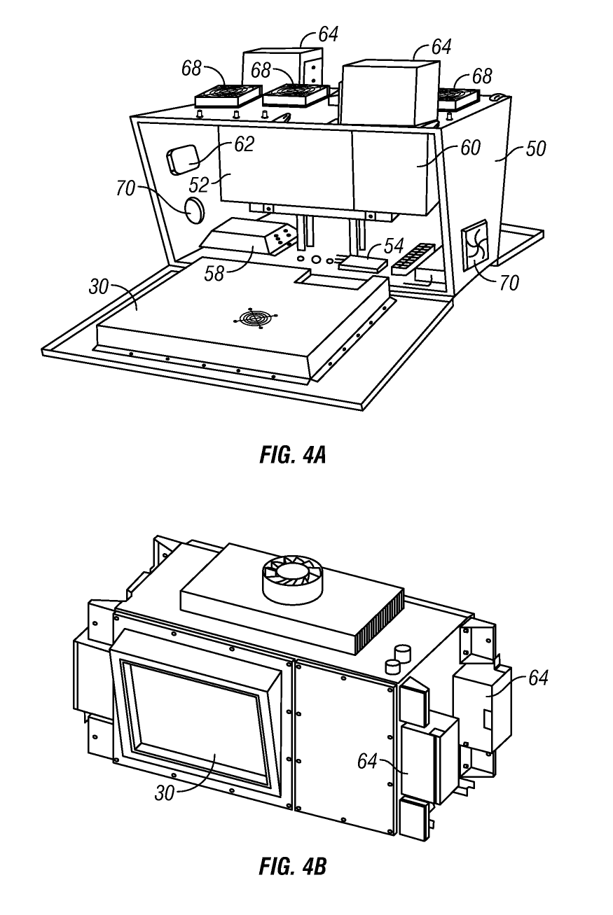

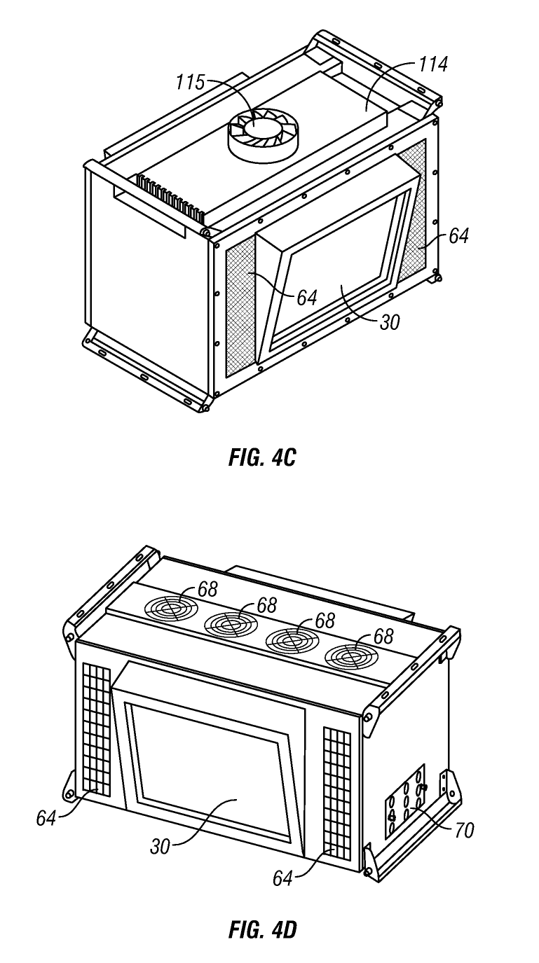

As mentioned above, in some advantageous embodiments, at least some of the display components are provided in a separate housing that can be added in a simple way to existing gas pumps. This dramatically reduces the investment required for a gas station to implement a media display system. Referring now to FIG. 4A, the housing 50 may enclose a controller 52 (which may comprise a general purpose microprocessor based computer such as a standard IBM compatible PC) to control the video displays to play dynamic multimedia advertisements in real-time, a circuit board 54 including circuitry to detect the pump nozzle removal from the storage bay by monitoring the sensor 19 (FIG. 1), an audio amplifier 58 and a power supply 60.

In order to fulfill the function of transmitting information, displays 30 are in installed in the front and the rear of the housing 50, which may comprise hinged door panels. The housing 50 may have a trapezoidal cross section so the display faces are directed slightly downward toward the viewer. In some embodiments, a VGA splitter 62 is set inside the box. The VGA splitter 62 divides the video signals output by the controller 52 into two sets of signals, to make the two displays 30 on each side show the same images simultaneously.

The video display 30 can be CRT electronic displays, plasma display (PDP), LED display, normal LCD display (LCD), or high-brightness LCD display (VHB LCD). When the CRT electronic displays, plasma displays (PDP), LED displays, and normal LCD displays are put outdoors, the images shown are not clear in the direct sunshine and the visual angles are narrow. When the high-brightness LCD displays (VHB LCD) are used outdoors, the images are very clear with bright colors and wide visual angles, so the high-brightness LCD displays have been found advantageous in many embodiments.

The audio amplifier 58 is connected to speakers 64 for providing sound to the user. The controller 52, installed in the enclosure 50 and used to control the video displays 30 and the speakers 64, may be configured such that when someone refills the tank, the controller 52 starts playing advertisements at the point when the pump was last shut off when a new user takes up the pump nozzle until the current cycle of refilling is ended and the pump nozzle is again replaced. The controller 52 can also obtain management information such as playing time and playing frequency of an advertisement or other content and transmit the management data to the management center, to track the total play time and frequency of a advertisement etc. of different pumps at different places; and download and update the audio/video content to be played.

The embodiment illustrated in FIG. 4A is air cooled by fans 68 mounted on top of the housing 52. During operation, the fans 68 force warm air inside the box upward and outward, and let in the cool air from outside through ventilation openings 70. In addition, a rain-proof and dust prevention cover (not shown) may be installed on the outside of the enclosure.

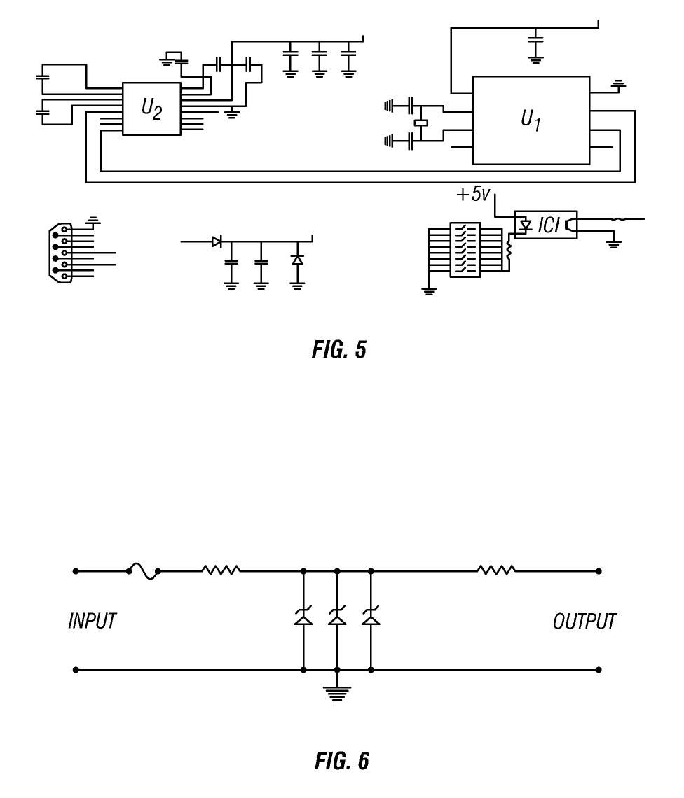

FIG. 5 is a schematic diagram of one embodiment of the circuit board 54 which monitors the pump nozzles. As shown in this Figure, it may comprise an optical coupler ICI, a microprocessor U1 and an electronic converting chip U2. By means of connecting the anode of diode in the optical coupler ICI to a 5V power supply, connecting the cathode of ICI to the action signal output side of the pump nozzles, connecting the collector of triode in the optical coupler ICI to the signal input side of the microprocessor U1, and connecting the signal output side of the microprocessor U1 to the serial port/parallel port (e.g. USB port) of the controller 52 via the voltage converting chip U2, the status signal of the pump nozzle is transmitted to the controller 52 at any time, so as to make the controller 52 play advertisements and other information based on the status of the pump nozzles.

In some embodiments, to help prevent damage or malfunction due to overheating, a thermostat switch is provided on the power supply 60. In this embodiment, a thermostat switch is in serial connection with the input side of the power supply 60, and the thermostat switch is provided with a function of monitoring the internal ambient temperature in the box. Once the internal temperature in the box exceeds the range of the normal operation temperature of electronic elements (preset), the thermostat switch will immediately cut off the output of the switch power supply and switch off all the electric equipments; when the internal temperature in the box drops to a safely low temperature value, the thermostat switch power supply will resume the power output.

In some embodiments, the housing 50 is designed to be explosion proof. Because the area around the gas pump may be an explosive environment with flammable gas fumes present, one aspect of the invention is the incorporation of at least some of the electrical components of the audio/video display system into an explosion proof housing. In some cases, such as when the display apparatus is located above the hose connections to the pump (e.g. FIG. 2), an explosion proof housing is not always necessary. However, it becomes a significant concern when the display apparatus is located below the hose connection to the pump (e.g. FIG. 3).

The basic design of explosion proof housings is known, and commercial providers of such housings are available. Making the system explosion proof requires addressing several different concerns. One concern is the connection to the pump nozzle storage bay sensor switch 18a. To meet requirements for explosion-proof systems and to improve the explosion-proof quality of gas pump's box, a safety fuse circuit may be implemented at the switch of the pump nozzles. As shown in FIG. 6, the safety fuse circuit mainly consists of a fuse and a regulator tube, mainly to limit the voltage and the current; the safety fuse circuit is in series connection with the pump nozzle switches, and RVV-2×0.5 mm² cables are used for connection. Once the voltage or the current of the pump nozzle circuit exceeds the values limited by the circuit component zener diodes and fuse, the safety fuse circuit will cut off the circuit connection between the video displays and the pump nozzle signals immediately. Another issue to be addressed is the sound system. In the explosion proof embodiment, passive speakers are mounted entirely internal to the housing 50. Still another issue to be addressed in the explosion proof design is cooling. Air can not be circulated through the enclosure from outside as in the embodiment shown in FIG. 4. In the explosion proof version, the enclosure may contain a cooling unit mounted to the inner wall of the enclosure. The cooling unit may comprise essentially a radiator with tubes or passages that communicate with input/output ports on the outside of the housing. The passages can then be air-cooled, water-cycled, or compressor-refrigerated, for example from outside the housing.

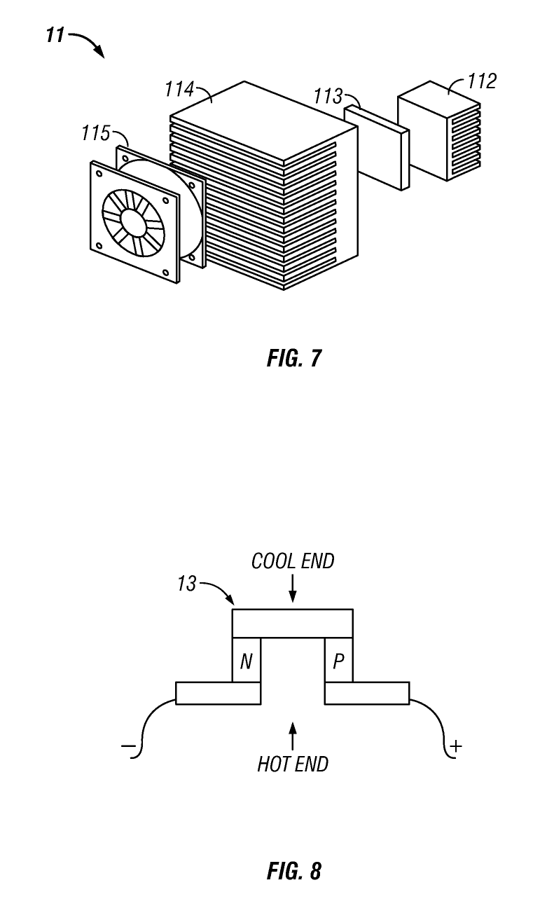

In one advantageous embodiment, semiconductor-chip refrigeration (e.g. a Peltier cooling device) may be used. As shown in FIGS. 7 and 8, a semiconductor electronic-chip refrigerated cooling unit includes the radiator 112, the semiconductor refrigerator 113, the radiator 114 and the fan 115. The cool end of the semiconductor refrigerator 113 is located inside the box, on which the radiator 112 is fixed for absorbing the heat generated by the video display 30, the control computer 52, the circuit board 54, as well as the power circuit 44 etc. and to reduce the internal temperature in the box; the heat end of the semiconductor refrigerator 113 is located outside the box, on the surface of which the radiator 114 and the fan 115 are fixed for radiating the heat absorbed by the semiconductor refrigerator 113 to keep it in a certain temperature. FIG. 8 is a diagram of the internal structure of the semiconductor refrigerator 113. No refrigerant is required for these devices, which are commercially available. The quantity of the electronic chips of the semiconductor refrigerator can be any number of devices as needed, such as 8 pieces, 10 pieces, or 12 pieces based on the heat volume generated by the components inside the housing. In addition, fans can be installed on the cool end of the semiconductor refrigerator 113 for the purpose to shorten the radiation time and to improve the radiation effect.

In some embodiments, a thermostat switch is designed at the power input side of the semiconductor refrigerator 113, and this thermostat switch is connected to a temperature sensor set inside the enclosure. During the operation process of the equipments, only when the internal temperature in the box reaches the set temperature does the semiconductor refrigerator 113 start working; while the internal temperature in the box does not reach the temperature set, the semiconductor refrigerator 113 is not powered.

FIGS. 4B-4D illustrate embodiments of audio/video player housings in closed configurations, including both air circulating embodiments, and sealed explosion proof embodiments.

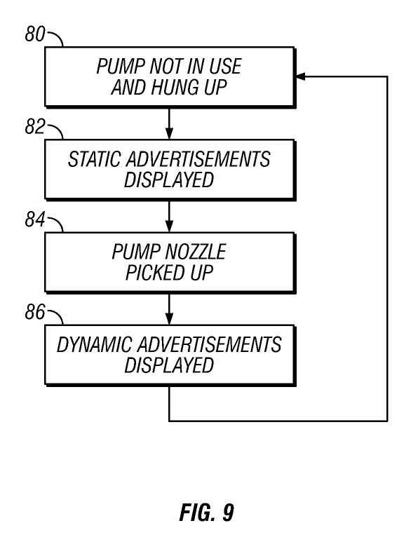

FIG. 9 is a flow chart of one operational sequence which may be undertaken by the displays under the control of the controller. As shown in this Figure, when the gas pump is idle and the pump nozzle is hung up at block 80, the controller 52 makes the displays 30 play static advertisement pictures at block 82 which typically do not change frequently. When someone takes up the pump nozzle for fuelling at block 84, the circuit board detects such a status and notifies the controller 52, whereupon the controller controls the video displays to start playing dynamic multimedia advertisements at block 86 which have been pre-stored in the memory of the controller. Looping back to block 80 after the fuelling is finished and the pump nozzle is hung up, the circuit board notifies the controller 52 of this status, and the controller stops displays playing dynamic advertisements and returns to playing static advertisements.

Embodiments of the invention not only use high-brightness LCD displays on gas pumps, but also realize the objective to play various information based on the signals of the pump nozzles being taken up/hung up. The system can automatically test the actions of the pump nozzle of being taken up/hung up and automatically play the information of various contents including images and sound according to the pump nozzle actions, and account the playing time, frequency, content, and order of various information. Also, the system can perform communications with the management center at different places, transmit various information and update the advertisement content via wired network modes (such as ISDN, ADSL, or DDN dedicated line, etc.) or wireless modes (such as CDMA, GPRS, satellites, 802.11 wireless LAN, etc.). Furthermore, embodiments of the invention have not only solved an issue of applying displays in such explosive dangerous environments as gas stations, but also solved an issue of heat radiation of the electric equipments so as to ensure a safe and normal operation of the electric equipments and gas pumps in the explosive dangerous area. The above mentioned is the specific practice and the technical application principle of various invention embodiments. The scope of the invention is defined by the following claims, and any equivalents should be within the protective range of this invention.

What is claimed is:

1. A gasoline pump apparatus comprising:
one or more pump nozzles;
a sensor configured to detect nozzle removal from and replacement to a nozzle storage bay;
a first housing enclosing at least some gas dispensing apparatus;
a second housing enclosing at least one video display and at least one video display controller; wherein said at least one video display controller is coupled to said sensor such that said video display output changes with changes in nozzle position.

2. The gasoline pump apparatus of claim 1, wherein said second housing is configured to be explosion proof.

3. The gasoline pump apparatus of claim 1, wherein said second housing is attached as a retro-fit onto said first housing.

4. A gasoline pump apparatus comprising:
one or more pump nozzles;
a first housing enclosing at least some gas dispensing apparatus;
a second explosion proof housing attached to said first housing and enclosing at least one video display and at least one video display controller.

5. The gasoline pump apparatus of claim 4, wherein said video display controller is coupled to a remote control facility via a communication channel.

6. The gasoline pump apparatus of claim 5, wherein said communication channel comprises at least a portion which is wireless.

7. The gasoline pump apparatus of claim 4, comprising a cooling system.

8. The gasoline pump apparatus of claim 7, wherein said cooling system comprises a water cooled radiator.

9. The gasoline pump apparatus of claim 8, wherein said cooling system comprises a semiconductor refrigerator.

10. A method of providing a gas pump with media display capability comprising:
attaching a second housing to the top of an existing pump apparatus housing;
routing power wiring and pump nozzle sensor wiring between said first and second housings; and
coupling media display control circuitry in said second housing to a remote control system.

11. The method of claim 10, wherein said coupling is performed wirelessly.

12. The method of claim 10, additionally comprising transmitting content from said remote control system to said media display control circuitry.
